(19) United States
(12) Patent Application Publication
(10) Pub. No.: US 2018/0122214 A1
(43) Pub. Date: May 3, 2018

(54) HAND HYGIENE SYSTEM

(71) Applicants: Johnson Controls Technology Company, Milwaukee, WI (US); Tyco Fire & Security GmbH, Neuhausen am Rheinfall (CH)

(72) Inventors: Seth Freedman, Miami, FL (US); Mohammed Mohiuddin, Boynton Beach, FL (US); Melwyn F. Sequeira, Plantation, FL (US); Mike Cronin, Crosshaven / Co. Cork (IE); Glenn Fitzpatrick, Cork (IE); James Hurley, Cork (IE); Denis Canty, Limerick (IE); John D. Perkins, Lake Worth, FL (US); Michael S. Beck, Bull Valley, IL (US); Hubert A. Patterson, Boca Raton, FL (US)

(21) Appl. No.: 15/796,452

(22) Filed: Oct. 27, 2017

Related U.S. Application Data
(60) Provisional application No. 62/413,706, filed on Oct. 27, 2016.
(60) Provisional application No. 62/459,811, filed on Feb. 16, 2017.
(60) Provisional application No. 62/527,876, filed on Jun. 30, 2017.

(51) Int. Cl. G08B 21/24; G08B 7/06

(52) U.S. Cl. CPC G08B 21/245; G08B 7/06

(57) ABSTRACT

A hand hygiene monitoring system is provided. The hand hygiene monitoring system includes a wearable device coupled to a user, and a beacon associated with a hand hygiene station and configured to communicate with the wearable device. The wearable device is configured to initiate monitoring for a hand hygiene operation based on determining the wearable device is located within a predetermined distance from the beacon, and monitor hand hygiene parameters associated with the hand hygiene operation. The hand hygiene parameters are associated with a quality level of the hand hygiene operation performed by the user.

### CROSS-REFERENCE TO RELATED PATENT APPLICATIONS

This application claims the benefit of and the priority to U.S. Provisional Patent Application No. 62/412,706, filed Oct. 27, 2016, U.S. Provisional Patent Application No. 62/459,811, filed Feb. 16, 2017, and U.S. Provisional Patent Application No. 62/527,876, filed Jun. 30, 2017. The entire disclosure of each of these patent applications is incorporated by reference herein.

### BACKGROUND

The present disclosure relates generally to methods and systems for monitoring and improving hand hygiene in multiple environments. Hand hygiene is an important, and sometimes overlooked, aspect of many environments and occupations. For example, hand hygiene is a critical component of the daily routine of health care workers, restaurant/food preparation/food processing workers, and the like. For example, one of the main routes for transmission of infections between patients is improper hand hygiene by health care workers. While workers may be conscious and diligent in their handwashing routines, recent studies have shown that health care workers were generally only washed twenty-five percent of the recommended times. Many hospitals, clinics, restaurants, and food processing plants have implemented various strategies to encourage hand-washing/sanitizing, as well as various processes to ensure compliance among employees/workers. For example, many hospitals or other health care facilities have implemented the World Health Organization's (WHO) “Hand Hygiene Guidelines in Health Care” that describe best practices for hand-washing and other hygiene events.” However, even with guidelines and processes implemented, adherence to the policy is not always achieved, and monitoring the compliance can be difficult due to the number of workers to monitor, and the required number of hand-washes/sanitizations per day. Thus, there is a need for systems and methods for hand hygiene monitoring and compliance determinations in various environments.

### SUMMARY OF THE INVENTION

One embodiment of the disclosure relates to a hand hygiene monitoring system. The hand hygiene monitoring system includes a wearable device coupled to a user, and a beacon associated with a hand hygiene station and configured to communicate with the wearable device. The wearable device is configured to initiate monitoring for a hand hygiene operation based on determining the wearable device is located within a predetermined distance from the beacon, and monitor hand hygiene parameters associated with the hand hygiene operation. The hand hygiene parameters are associated with a quality level of the hand hygiene operation performed by the user.

In some embodiments, the one or more hand hygiene parameters include a duration of the hand hygiene operation and a movement level of the hand hygiene operation.

In some embodiments, the wearable device is further configured to analyze the one or more hand hygiene parameters to determine the quality level of the hand hygiene operation performed by the user.

In some embodiments, a space associated with the hand hygiene station is at least one of a bathroom or a kitchen.

In some embodiments, the wearable device includes a communication circuit, a processing circuit, an accelerometer, a gyroscope, and a feedback circuit. In other embodiments, the communication circuit includes one of a Bluetooth circuit, a near field magnetic induction circuit, a near field communication circuit, and a radio frequency identification circuit.

In some embodiments, the hand hygiene monitoring system further includes a central controller in communication with the communication circuit of the wearable device. The wearable device is configured to transmit the one or more hand hygiene parameters to the central controller during at least one transmission event. The central controller is configured to analyze the one or more hand hygiene parameters to determine the quality level of the hand hygiene operation performed by the user. In various embodiments, the transmission event is an end of a shift of the user. In other embodiments, the transmission event is a determination that the wearable device is located within the predetermined distance from the beacon.

In some embodiments, the hygiene station is provided in a space within a building, and the central controller is located on a server within the building. In other embodiments, the central controller is located on a cloud server.

In some embodiments, the feedback circuit comprises a haptic motor configured to provide haptic feedback to the user based at least in part on the quality level of the hand hygiene operation performed by the user.

Another implementation of the present disclosure is a method of provisioning a wearable device in a hand hygiene compliance system. The method may be performed by a hand hygiene compliance system gateway device, and includes receiving a user input from one of multiple users, selecting a selected wearable device from multiple wearable devices based on the user input, transmitting a signal to the selected wearable device to perform a selection indication action, and associating the user with the selected wearable device. The wearable device is configured to monitor one or more hand hygiene parameters associated with a hand hygiene operation.

In some embodiments, the hand hygiene compliance system gateway device includes a charging hub for the multiple wearable devices. The multiple wearable devices may be charged via wired or wireless (inductive) means.

In some embodiments, the wearable device includes a communication circuit, a processing circuit, an accelerometer, a gyroscope, and a feedback circuit.

In some embodiments, the feedback circuit is configured to perform the selection indication action. The selection indication action includes a vibration action or an LED flashing action.

Yet another implementation of the present disclosure is a monitoring system. The monitoring system includes a wearable device coupled to a user, and a beacon provided within a space and configured to communicate with the wearable device. The wearable device is configured to monitor for a hand movement operation when the wearable device is determined to be located within a predetermined distance from the beacon. The wearable device is further configured to monitor one or more hand movement parameters associated with the hand movement operation. The one or more hand movement parameters are associated with a quality level of the hand movement operation performed by the user.

In some embodiments, the wearable device includes a communication circuit, a processing circuit, an accelerometer, a gyroscope, and a feedback circuit. In other embodiments, the communication circuit includes one of a Bluetooth circuit, a near field magnetic induction circuit, a near field communication circuit, and a radio frequency identification circuit.

In some embodiments, the wearable device is configured to continue monitoring for a hand movement operation when the wearable device moves outside the predetermined distance from the beacon after being within the predetermined distance from the beacon.

### BRIEF DESCRIPTION OF THE DRAWINGS

FIG. 1 is a schematic diagram of a hand hygiene system, according to some embodiments.

FIG. 2 is a perspective view of a charging hub used in the hand hygiene system of FIG. 1, according to some embodiments.

FIG. 3 is a block diagram of the charging hub of FIG. 2, according to some embodiments.

FIG. 4 is a perspective view of a hand hygiene module used in the hand hygiene system of FIG. 1, according to some embodiments.

FIG. 5 is a perspective view of the interior components of the hand hygiene module of FIG. 3, according to some embodiments.

FIG. 6 is a block diagram of the hand hygiene module of FIG. 3, according to some embodiments.

FIG. 7 is another perspective view of the hand hygiene module of FIG. 3, according to some embodiments.

FIG. 8 is a perspective view of the hand hygiene module of FIG. 3 installed in a wristband, according to some embodiments.

FIG. 9 is a front elevation view of the wristband of FIG. 8, according to some embodiments.

FIG. 10 is another perspective view of the wristband of FIG. 8, according to some embodiments.

FIG. 11 is a flow diagram of a method of provisioning a hand hygiene module wristband in the hand hygiene system of FIG. 1, according to some embodiments.

FIG. 12 is a flow diagram of a method of downloading data from a hand hygiene module wristband in the hand hygiene system of FIG. 1, according to some embodiments.

FIG. 13 is a flow diagram of a method for determining a duration of presence of a user in a room with hand washing facilities in the hand hygiene system of FIG. 1, according to some embodiments.

FIG. 14 is a schematic diagram of a hand hygiene monitoring system for a bathroom using the hand hygiene system of FIG. 1, according to some embodiments.

FIG. 15 is a schematic diagram of a hand hygiene monitoring system for a kitchen using the hand hygiene system of FIG. 1, according to some embodiments.

FIG. 16 is a flow diagram of a method for monitoring hand hygiene in a bathroom, according to some embodiments.

FIG. 17 is a flow diagram of a method for monitoring hand hygiene in a kitchen, according to some embodiments.

FIG. 18 is a flow diagram of a method for monitoring soap dispenser access, according to some embodiments.

FIG. 19 is a flow diagram of a method for monitoring glove dispenser access, according to some embodiments.

FIG. 20 is a flow diagram of a method for changing the personality of a hand hygiene module wristband, according to some embodiments.

FIG. 21 is a schematic diagram of a hand hygiene finite state machine that can be implemented in the hand hygiene system of FIG. 1, according to some embodiments.

FIG. 22 is a schematic diagram of a vision-based hand hygiene system, according to some embodiments.

### DETAILED DESCRIPTION

Embodiments provide a method and system for hand hygiene monitoring. According to one aspect, a hand hygiene monitoring system includes a first set of beacons configured to detect a presence of a hand hygiene module (HHM) within a room for a configurable minimum period of time. The hand hygiene system also includes a second set of beacons configured to be distributed at an exit of the room and configured to detect an exit of the HHM from the room. When the HHM is within the room for the configurable minimum period of time and then exits without a recording of a hand hygiene operation, an infraction event is recorded. A hand hygiene operation includes, for example, a handwashing event with soap, a handwashing event with hand sanitizer, and a removal of gloves from a glove dispenser.

Although good hand hygiene is generally accepted as important, in hospitals, doctor offices and restaurants, for example, there is a particular need for personnel to wash their hands before leaving a restroom or making contact with a next patient or customer. A wristband with a hand hygiene module (HHM) may be worn by a person to ensure that adequate hand washing by a person within the room occurs. In particular, the HHM carried by the wristband detects when a person places his or her hands in the vicinity of a soap dispenser, and further detects whether, after placing hands in the vicinity of the soap dispenser, the user engages in a hand washing motion for a predetermined of time and with sufficient vigor.

To accomplish this, the hand hygiene module may include a communication module such as a low energy Bluetooth (BLE) receiver to detect when the hand hygiene module is in the vicinity of the soap dispenser, where the soap dispenser emits a low energy beacon detectable by the receiver of the hand hygiene module. The invention is not limited solely to Bluetooth communications. It is contemplated that other communication technologies can be used such as those based on light, audio or other wireless technologies, for example, near field magnetic induction (NFMI) technology, near field communication technology, and radio frequency identification technology. Further, in some embodiments, the HHM may be or may be part of a smart watch or a fitness tracker, such as a wearable fitness tracker.

The HHM also includes an accelerometer or gyroscope to detect motion of the hands when the wristband having the HHM is worn on the wrist of the user. If the motion of the hands does not occur within a certain period of time of coming in contact with or within the vicinity of the soap dispenser, the HHM may emit a sound or a flashing light from a light-emitting diode, for example, or may vibrate. If the washing motion of the hands does not continue for at least a certain period of time, once again, the HHM may emit an alarm. If the user leaves the room where the hand washing is to take place without washing his hands, a negative event is recorded in a memory of the HHM. At the end of a shift of the user of the wristband, the contents of the HHM memory may be transmitted by a transmitter of the HHM to a receiver of a computer which may display any negative events, as well as optionally correlate the negative event with a time duration of the HHM being detected in the room.

To detect hand washing compliance, the steps of hand washing detection, may be conditioned upon the detection of the user entering and being in the room where handwashing is to occur, which may be referred to as a presence event. Preferably, false detections of user presence based on activity outside the room are avoided. Some methods for avoiding false detections may involve checking the movement both in and out of the washroom. Another method is to create a low-level radio “blanket” within the room being monitored, and accurately detecting when the user exits the room.

In one embodiment, the determination of the hand washing event for which haptic feedback is given to the user may be based on a machine learning algorithm that uses model data corresponding to a particular, i.e., specific, application. For example, the model data may vary depending on whether the unit is being deployed in a medical facility such as a hospital, restaurant, or domestic premises, i.e., someone's home. This model data may include learning data based on the accelerometer and/or gyroscopic results of a predetermined number of hand washes of the type corresponding to the specific application, where the predetermined number provides a sample size large enough to provide a reliable model. For example, hand washing requirements in an operating room are likely more stringent than at a child day care center, so the learning data used as the basis for determining a hand washing haptic event may differ between the operating room and the child day care.

In cases where the HHM is or is part of a smart watch or a fitness tracker, such as a wearable fitness tracker, the analysis to determine a proper hand washing event can be an “app” written for the device. The smart watch or the fitness tracker can communicate with a smart phone, tablet, etc., or to a Bluetooth access point to aggregate the data. The data can then be processed at the smart phone/tablet, or other computing device to determine the hand washing event.

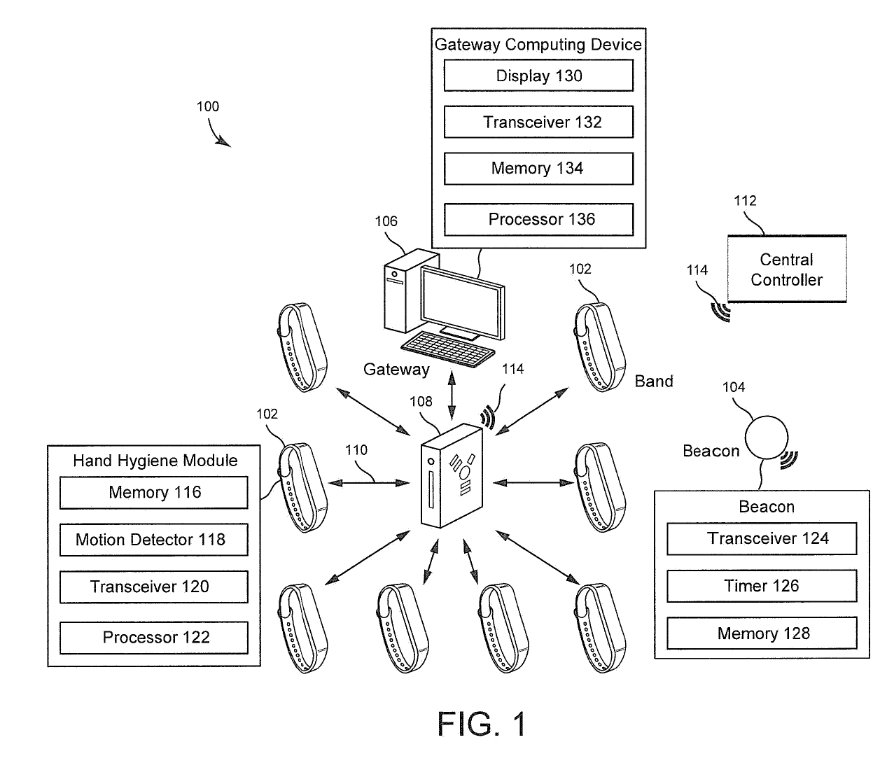

Referring now to FIG. 1 a schematic diagram of a hand hygiene monitoring or compliance system 100 is depicted, according to some embodiments. Hand hygiene monitor system 100 includes, among other components, at least one hand hygiene module (HHM) enclosed within a wristband 102, at least one beacon 104, and a gateway system comprising a gateway computing device 106 and a central hub 108. The HHM wristbands 102 may connect to the gateway system via communications interface 110. In some embodiments, communications interface 110 is a universal serial bus (USB) interface. Hand hygiene monitoring system 100 is also shown to include a central controller 112. The central controller 112 may communicate with the gateway system via communications interface 114. In various embodiments, communications interface 114 is a Bluetooth interface, a Wi-Fi interface, a cellular network interface, or a hardwired connection.

The components of the hand hygiene monitor system 100 will generally not be collocated. For example, gateway computing device 106 and central hub 108 may be at a central location where users that wear the HHM wristbands 102 can check in and check out. Central controller 112 can be at a location to service multiple different customers, such as via a cloud-based service in which event data is transmitted from HHM wristbands 102 and/or beacons 104 to the central controller 112 for further analysis and processing. The beacons 104, as noted above, are distributed about the interior and exit of a restroom or other room having hand washing facilities, or arrayed on a door entrance to indicate entrance to an area of special sensitivity to hygiene (e.g., a patient room).

When a worker, such as a health care worker or food service worker, checks in at the start of a work shift, the worker obtains an HHM wristband 102 that is configured to detect a low power beacon 104. In various embodiments, the beacon 104 may be a stick-on beacon that is located on a soap dispenser, a glove dispenser, and at the entryways and exits of rooms (e.g., a bathroom, a kitchen). The beacon 104 may comprise, among other components, a transceiver 124, a timer 126, and memory 128. At the end of a shift, the user returns the HHM wristband 102 to the gateway computing device 106 and central hub to have the contents of the hand hygiene module memory 116 wirelessly transmitted to the gateway computing device 106 via a transceiver 132 of the gateway computing device 106. As noted above, in another embodiment, the central controller 112 is not co-located with the workers. In this case, the contents of the hand hygiene module memory 116 can be transmitted across a network, i.e., through the “cloud”, to the central controller 112. In an alternative embodiment, the hand hygiene module memory contents can be transferred by wire, such as USB interface 110, to the gateway computing device 106. The contents of the hand hygiene module memory 116 may thus be transferred to a memory 134 of the gateway computing device 106. The gateway computing device processor 136 may process the contents of the memory 134 and display the processed contents via a display 130, such as a video monitor, or may transmit the processed contents to another computing device (e.g., central controller 112) for analysis and presentation to hygiene monitoring personnel.

The contents of the memory 116 of the hand hygiene module may include a result value or quality level that is a result of a determination whether a compliant hand wash has occurred. This result value will be passing value of the compliant hand wash has occurred during a restroom visit and will be a failure value if a compliant hand wash has not occurred during a trip to the restroom. The result value may be displayed by the display 130 to show whether the worker to whom the HHM wristband 102 is assigned has complied with hand washing rules. The contents of the memory 116 may also include presence data including a presence start time and an exit time.

The hand hygiene module may also have a motion detector 118 and a transceiver 120. The motion detector 118 may be an accelerometer and/or a gyroscope to detect hand washing motion. The transceiver 120 may receive a low power radio signal from a soap dispenser when the HHM wristband 102 is in proximity to the soap dispenser, such that the received low power signal exceeds a threshold as determined by a processor 122. The processor 122 may also process signals from the motion detector 118 to determine how long the hand washing motion continues and to emit an alert if the motion does not continue for a predetermined amount of time (e.g., 15 seconds). The processor 122 may evaluate the extent of motion to determine if hand washing is vigorous enough.

In some embodiments, the beacons 104 may each have a transceiver 124 that can detect a presence of an HHM wristband 102 in the room or exiting the room. For example, the transceiver 120 of the HHM wristband 102 may transmit a low level radio signal that can be detected by a transceiver 124 of the beacons 104. In alternative embodiments, the transceivers 124 of the beacons 104 may emit a low power signal which, when received by the HHM wristband 102, indicate to the HHM wristband 102 that it is in the room. Also, in some embodiments, a timer 126 in the beacon 104 may determine how long the HHM wristband 102 is in the room and compare the determined time to the configurable minimum period of time and to the configurable maximum period of time discussed above. In alternative embodiments, these times are determined in the HHM 14.

The presence data, which can be stored in the memory 128, can be transmitted to the HHM wristband module 102, which stores the timing information in the memory 116. This information can then be provided to the gateway computing device 106 which may display the information on the display 130. Thus, either the processor 122 of the HHM wristband module 102 or the processor 136 of the gateway computing device 106 may correlate the time during which the worker is in the restroom with a time during which a compliant or non-compliant hand washing occurs.

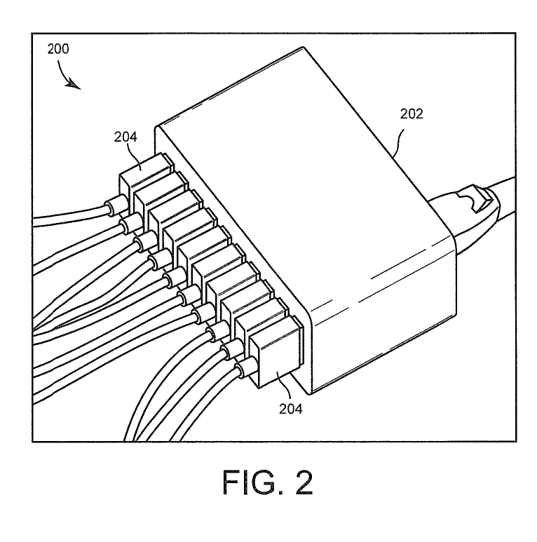

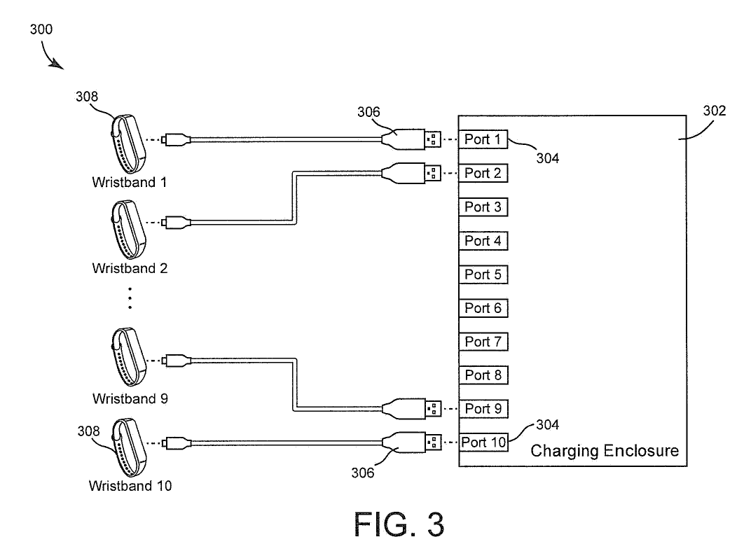

Referring now to FIGS. 2-3, a schematic view and a block diagram of a central hub are shown, according to some embodiments. As described above, the central hub may be configured to communicably couple to multiple HHM wristbands for the purposes of charging the batteries of the HHM wristbands, and downloading data stored in the memories of the HHM wristbands. The central hub may also be configured to communicably couple to a gateway computing device. FIG. 2 depicts central hub 200 as having a charging enclosure 202, with multiple ports to receive USB cables 204. FIG. 3 depicts central hub 300 as having a charging enclosure 302 with multiple ports 304. Each of the ports 304 are configured to receive a USB cable 306, and each of the USB cables 306 is configured to mate with an HHM wristband 308. In some embodiments, the USB cable may be replaced for charging purposes by wireless (inductive) charging and for data transmission purposes by a wireless data transmission protocol such as Bluetooth.

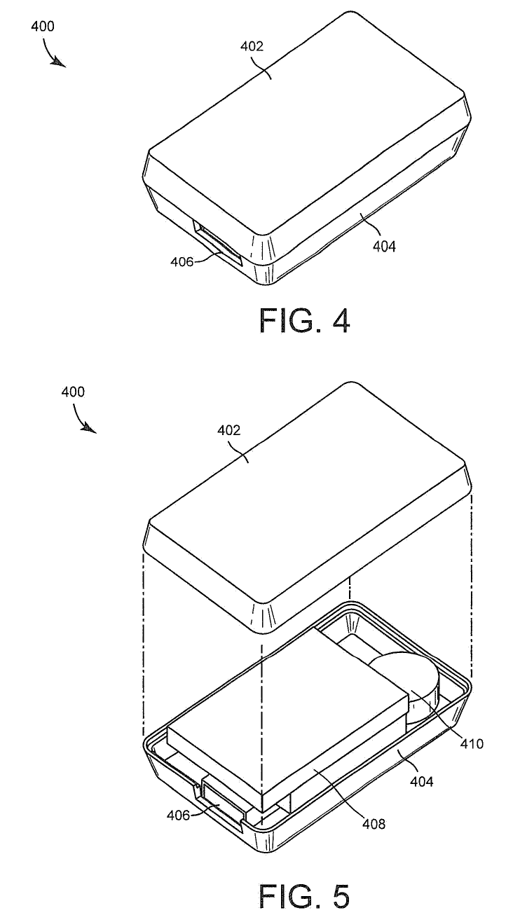

Turning now to FIGS. 4-6, several perspective views of an HHM 400 are shown, according to some embodiments. As shown in the top perspective view of FIG. 4, HHM 400 is shown to include a top cover 402 and a bottom cover 404 that are coupled to each other via any suitable means (e.g., snap-fit features, fasteners, adhesives) to substantially enclose the electronic components of the HHM 400. In addition, HHM 400 is shown to include a USB port 406, which is configured to receive a USB cable (e.g., USB cable 204, USB cable 306, described above with reference to FIGS. 2-3) to enable HHM 400 to connect to the gateway computing device central hub (e.g., charging enclosure 202, charging enclosure 302, described above with reference to FIGS. 2-3). In some embodiments, HHM 400 does not include USB port 406, because the USB cable may be replaced for charging purposes by wireless (inductive) charging and for data transmission purposes by a wireless data transmission protocol such as Bluetooth.

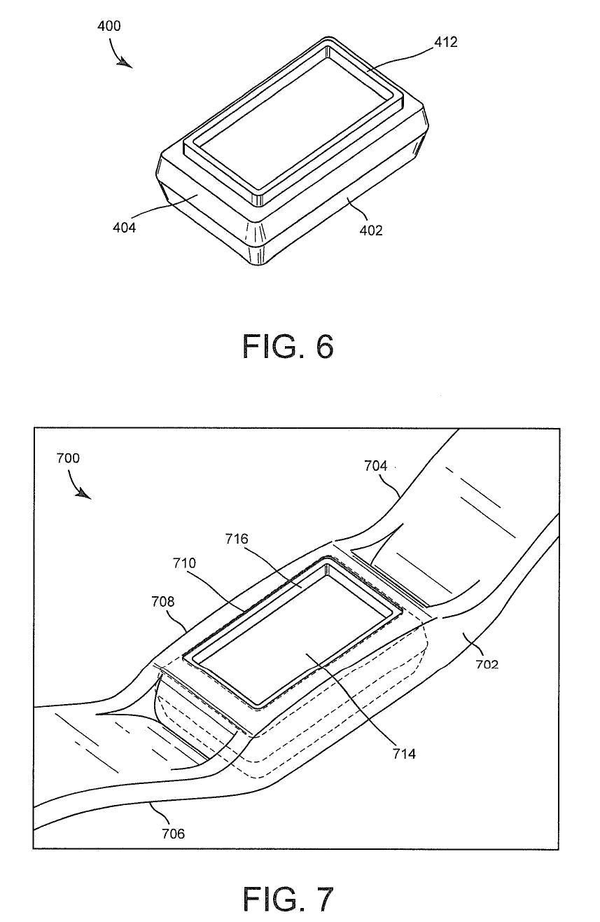

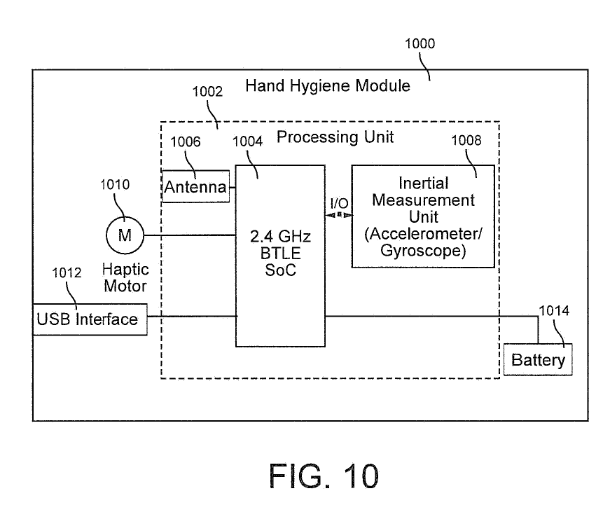

Referring now to FIG. 5, an exploded top perspective view of HHM 400 is depicted. In various embodiments, the interior electronic components of HHM 400 enclosed by top cover 402 and bottom cover 404 include, but are not limited to, a processing circuit 408 and a rechargeable battery 410. Further details of the electronic components of the HHM are included below with reference to FIG. 10. FIG. 6 depicts a bottom perspective view of HHM 400. As shown, bottom cover 404 may include a retaining lip feature 412 that functions to position the HHM 400 in a correct orientation when installed in a wristband.

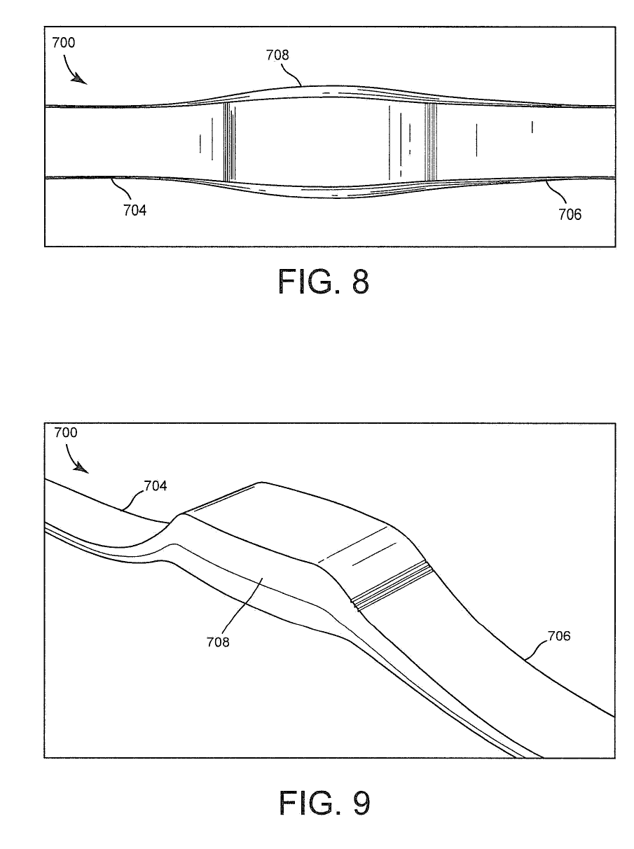

FIGS. 7-9 depict several views of an HHM wristband 700. Specifically, FIG. 7 depicts a bottom perspective view of HHM wristband 700, while FIGS. 8-9 respectively depict top elevation and top perspective views of HHM wristband 700. As shown, HHM wristband 700 includes a wristband 700 and an HHM 714. Wristband 700 includes a first band strap 704 and a second band strap 706. First band strap 704 and second band strap 706 may be configured to couple to each other to retain the wristband 700 around a user's wrist via any suitable fastening mechanism. Located between the first band strap 704 and the second band strap 706 is a central band portion 708. The central band portion 708 includes a central aperture 710 configured to receive an HHM 714. In various embodiments, HHM 714 is identical or substantially similar to HHM 400, described above with reference to FIGS. 4-6. HHM 714 is shown to include a retaining lip feature 716 that functions to position the HHM 714 inside the central aperture 710 of central band portion 708.

Turning now to FIG. 10, a block diagram of an HHM 1000 is shown. In some embodiments, HHM 1000 is identical or substantially similar to HHM 400 and HHM 714, described above with reference to FIGS. 4-9. HHM 1000 is shown to include a processing unit 1002. The processing unit 1002 includes, among other components, a Bluetooth (BTLE) system on chip (SoC) 1004, a Bluetooth antenna 1006, and an inertial measurement unit 1008. In various embodiments, the inertial measurement unit 1008 includes an accelerometer and/or a gyroscope. The BTLE SoC 1004 may include, among other components, a processor and a memory device. In some embodiments, HHM 1000 does not operate using Bluetooth technology. Instead, other communication technologies such as those based on light transmission (LiFi), visual recognition via computer vision, audio or other wireless technologies, for example, near field magnetic induction (NFMI) technology, near field communication technology, and radio frequency identification technology, or a combination of these technologies to enhance the probability of successful detection.

HHM 1000 is further shown to include a haptic motor 1010, a USB interface 1012, and a rechargeable battery 1014. A feedback circuit may include a haptic motor 1010 configured to provide haptic feedback (e.g., vibrations) to the user wearing to the HHM wristband. In some embodiments, in addition to the haptic motor 1010, the feedback circuit includes one or more light emitting diodes (LEDs) that are configured to provide feedback to the user. As described above, the USB interface 1012 may be configured to couple to a USB cable for the purpose of charging the battery 1014 and downloading data stored in the memory of HHM processing unit 1002.

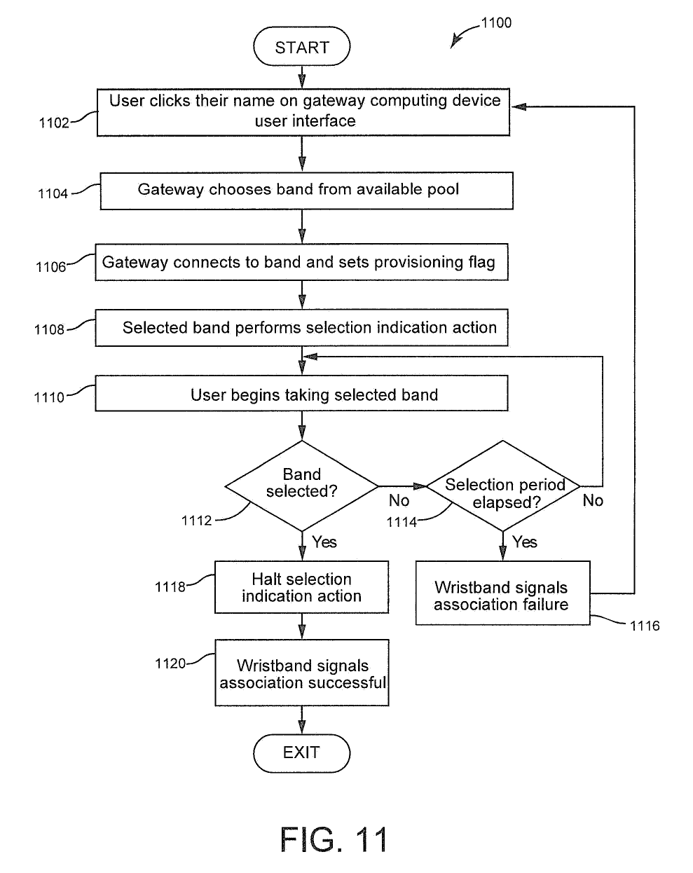

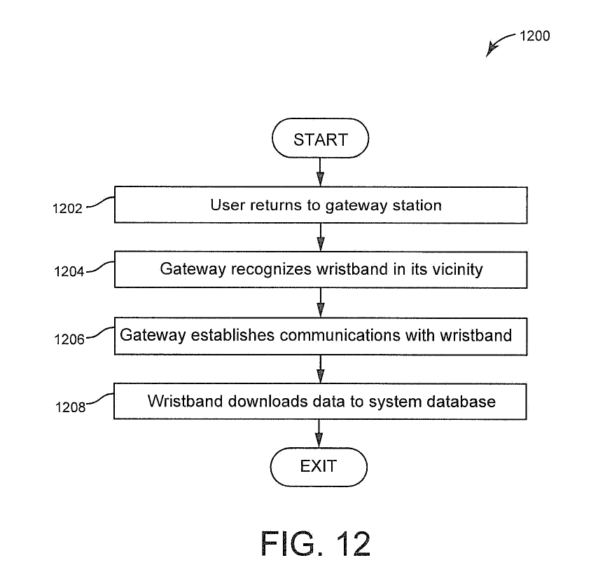

Referring now to FIG. 11, a flow diagram of a process 1100 for provisioning an HHM wristband is shown. The HHM wristbands may be configured to be “agnostic on the charger” in that users do not have designated HHM wristbands. Instead, a user must perform the provisioning process at the beginning of the user's shift in order to associate the user and the HHM wristband. In various embodiments, process 1100 may be performed by one or more components of hand hygiene system 100. Process 1100 begins as a user approaches a gateway system (e.g., gateway computing device 106 and central hub 108). At step 1102, the user utilizes the gateway computing device 106 to select the user's name, or other personal identifier via a user interface. For example, if the hand hygiene system is implemented in a hospital, the user interface may interface with a scheduling program such that only the names of healthcare providers assigned to particular shifts on particular floors/wards are selectable via the user interface.

At step 1104, the gateway computing device selects an HHM wristband from the pool of available wristbands connected to the charging hub. Once selected, the gateway computing device and the central hub connect to the wristband via the USB interface and trigger a provisioning flag in the HHM processing circuit at step 1106. In some embodiments, triggering the provisioning flag in the HHM processing circuit includes sending a signal to the selected wristband to perform a selection indication action. The selected wristband performs the selection indication action at step 1108. In various embodiments, the selection indication action may include, but is not limited to, vibrating or flashing an LED.

Continuing with step 1110, the user begins to remove the selected wristband from the charging hub. In some embodiments, the selection indication action (i.e., vibrating, flashing) performed by the selected wristband is configured to be performed continuously for a configurable selection period (e.g., 10 seconds). At step 1112, the HHM of the selected wristband detects whether the user has removed the selected wristband from the charging hub. For example, the HHM may utilize the accelerometer and/or the gyroscope to detect the motion of the user removing the selected wristband from the charging hub. If the HHM of the selected wristband does not detect that the user has removed the selected wristband, process 1100 proceeds to step 1114, in which the HHM determines whether the configurable selection period has elapsed. If the period has not elapsed, process 1100 reverts to step 1110, and the selected wristband continues to perform the selection indication action. If the configurable selection period has elapsed, process 1100 proceeds to step 1116 and the selected wristband signals a band association failure to the gateway computing device and the central hub. From there, process 1100 reverts to step 1102, and the user must select their name from the gateway computing device user interface once again.

Returning to step 1112, if the HHM detects that the user has removed the selected wristband from the charging hub, the HHM halts the selection indication action (e.g., vibrating, flashing) at step 1118. At step 1120, the HHM of the selected wristband wirelessly transmits a signal (e.g., via Bluetooth communications) to the gateway computing device and the central hub that the association between the selected wristband and the user was successful. Subsequent to step 1120, process 1100 concludes.

Turning now to FIG. 1200, a process 1200 for downloading data stored on an HHM wristband is shown. For example, process 1200 may be performed at the end of a user's shift to transfer data associated with hand hygiene operations over the course of the user's shift to the gateway system and/or a central controller. In various embodiments, process 1200 may be performed by one or more components of hand hygiene system 100, described above with reference to FIG. 1.

Process 1200 begins with step 1202, as a user wearing an HHM wristband (e.g., HHM wristband 102) returns to the vicinity of the gateway station (e.g., the gateway computing device 106 and the central hub 108). At step 1204, the gateway station recognizes the HHM wristband in its vicinity. For example, in some embodiments, the gateway station receives Bluetooth communications emitted by the HHM wristband. At step 1206, the gateway station establishes a wireless communications link with the HHM wristband. Finally, process 1200 concludes at step 1208, as the HHM wristband downloads data stored in the memory of the HHM to a system database (e.g., a database of gateway computing device 106). In other embodiments, the HHM wristband downloads data to a central hub (e.g., central hub 108) via a USB interface, and the central hub transfers the downloaded data to the system database.

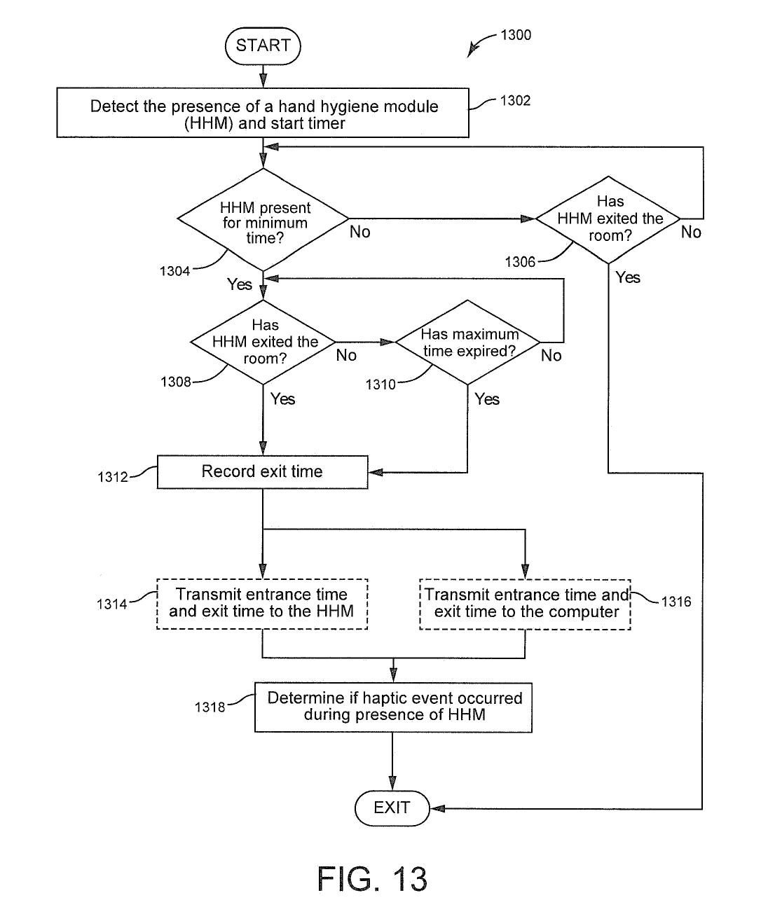

Referring now to FIG. 13, a flow diagram of a process 1300 for determining a duration of presence of a user in a room where hand washing facilities are provided (e.g., a bathroom, a kitchen) is shown. In some embodiments, process is performed by one or more components of hand hygiene system 100, described above with reference to FIG. 1. Specifically, process 1300 may be performed by HHM wristband 102 and a beacon 104. Process 1300 begins at step 1302, as a beacon detects the presence of an HHM and a timer is started. At step 1304, the beacon determines whether the HHM has been present in the room for a configurable minimum period of time (e.g., 10 seconds). If the beacon determines that the HHM has not been present in the room for a configurable minimum period of time, process 1300 proceeds to step 1306 to determine whether the HHM has exited the room. If the beacon determines that the HHM has not exited the room, process 1300 reverts to step 1304 and continues to determine if the HHM has been present for the configurable minimum period of time. If however, it is determined that the HHM has exited the room, process 1300 ends because the indication of presence is deemed to be false or of insufficient duration to record a haptic event.

If the beacon determines that the HHM has been present for the configurable minimum period of time at step 1304, process 1300 proceeds to step 1308, in which the beacon again determines if the HHM has exited the room. If not, step 1310 determines whether the configurable maximum period of time has expired, indicating that the HHM may have exited without detection. Process 1300 then returns to step 1308 to continue to monitor whether the HHM has exited the room. If the beacon detects that the HHM has exited the room or if the configurable maximum period of time has expired, a time of exit is recorded at step 1312.

In some embodiments, after an exit time is recorded, the entrance time and exit time are transmitted from the beacon to the HHM at step 1314 for upload to the gateway computing device and/or a central controller (e.g., gateway computing device 106, central controller 112) at the end of the worker's shift. In other embodiments, the entrance time and exit time may be transmitted from the beacon to the gateway computing device and/or the central controller at step 1316 either wirelessly or by wireline. When a worker turns in the worker's HHM wristband at the end of the worker's shift, at least the haptic event data is uploaded to the gateway computing device and/or the central controller which is then correlated at step 1318 with the HHM presence data to determine if and when a haptic success event (a compliant hand washing) has occurred or a haptic fail event (a non-compliant handwashing or no hand washing) has occurred. As battery technology improves and the power required by computing modules decreases, it may be possible to perform this upload step continuously, such that the HHM wristband transmits data whenever a suitable network comes into range, rather than once a day.

It should be noted that, although the embodiments described herein utilize beacons as the elements that detect wearer presence, implementations are not limited solely to beacons. It is contemplated that other forms of detection can be used including video motion detection and signal strength analysis. Also, although embodiments are described herein with respect to entry and exit detection events, this description is not intended to apply solely to entry and exit from a room such a bathroom. Rather, it is contemplated that the disclosure and embodiments are equally applicable to entry and exit from a defined area. For example, a hand washing event might be needed for personnel just arriving to work, i.e., entry to the workplace from the outside, or when changing locations within a premises, such as when moving from a meat preparation station to a vegetable preparation station within a restaurant.

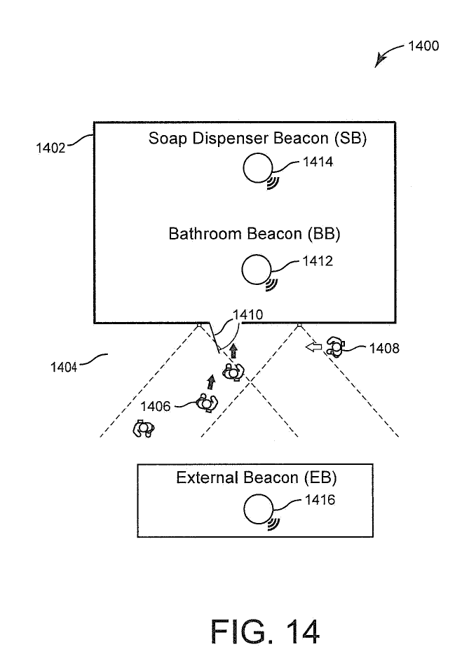

Referring now to FIG. 14, a schematic diagram of a bathroom hand hygiene system 1400 is shown, according to some embodiments. As shown, bathroom hand hygiene system 1400 may include, among other components, a bathroom 1402, a corridor 1404, one or more users 1406 entering the bathroom 1402 via the bathroom exit/entrance door 1410, and one or more users 1408 passing by, but not entering, the bathroom 1402. Bathroom hand hygiene system 1400 is further shown to include multiple beacons. The exact location of the beacons will depend on the layout of the bathroom 1402 and the exit/entrance door 1410 of the bathroom 1402, and the layout of the corridor 1404 outside the bathroom 1402. The layout may be chosen to achieve the ability to detect the presence of the user within the bathroom and to detect the exiting of the bathroom by the user. The detection of the presence of the user and the exit of the user as well as the duration of the presence of the user is referred to herein as presence data. As described above with reference to FIG. 13, process 1300 may be utilized to detect and record presence data.

The interior bathroom beacons (i.e., bathroom beacon 1412, soap dispenser beacon 1414) are located in various places within the bathroom 1402 to minimize blind spots. The exterior bathroom beacons (i.e., external beacon 1416) are located just outside the bathroom 1402, such as along the corridor 1404 and on the frame of exit/entrance door 1410 facing away from the bathroom 1402, to detect when a user leaves the bathroom 1402. Both interior and exterior beacon emissions may have a low power level (e.g., 40 dbm), such that the beacon signals does not penetrate walls of the bathroom 1402. The repetition rate of the beacon emissions may also be low (e.g., 4 Hz) so that the beacons can be implemented with simple, inexpensive electronics.

User entrance detection occurs when the user (e.g., user 1406) enters the bathroom 1402 and his or her HHM wristband is detected by one or more bathroom beacons 1412. The presence of the user 1406 is monitored to determine whether the user 1406 stays in the bathroom 1402 for a configurable minimum period of time, which may be defined in seconds. The configurable minimum period of time may be used to avoid false entrance detections when a person is standing outside the bathroom or walking past the bathroom entrance (e.g., user 1408). The larger the configurable minimum period of time, the greater the confidence of a decision that the user is actually inside the bathroom. However, the configurable minimum period of time should not be so great as to avoid detection of a person entering the bathroom and exiting the bathroom without washing hands before the expiration of the configurable minimum period of time.

Exit detection occurs when the user 1406 leaves the bathroom and the wristband is detected by the exit beacons. If the exit detection does not detect the user exit within a configurable maximum period of time, because for example, the wristband of the user 1406 is obscured by a crowd of people, then the exit detection will be triggered.

In some embodiments, the beacon detects an HHM wristband by sensing a signal emitted by the HHM wristband. In other embodiments, the beacon detects the HHM wristband by transmitting a signal and receiving a signal from the HHM wristband in response to the transmitted signal. In yet other embodiments, rather that the beacon detecting the HHM wristband, the HHM wristband determines its presence in the room and its subsequent exit when it passively receives a signal from an inside beacon and an exit beacon.

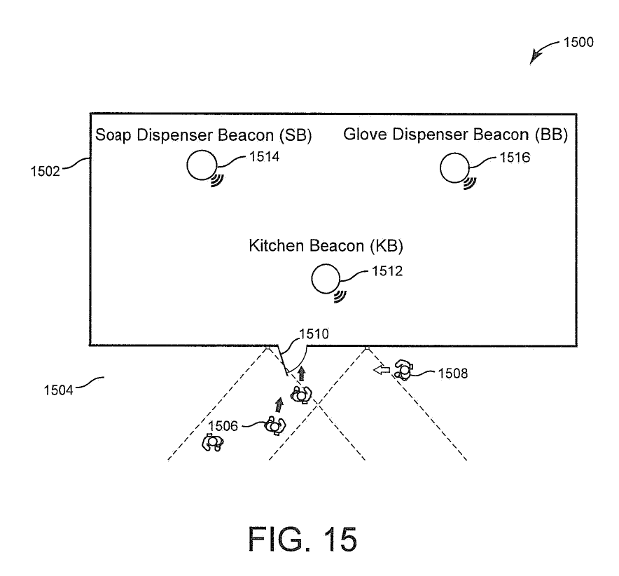

Referring now to FIG. 15, a schematic diagram of a kitchen hand hygiene system 1500 is shown, according to some embodiments. As shown, and similar to bathroom hand hygiene system 1400 described above with reference to FIG. 14, kitchen hand hygiene system 100 may include, among other components, a kitchen 1502, a corridor 1504, one or more users 1506 entering the kitchen 1502 via the kitchen exit/entrance door 1510, and one or more users 1508 passing by, but not entering, the kitchen 1502. Kitchen hand hygiene system 1500 is further shown to include multiple beacons. The exact location of the beacons (e.g., one or more kitchen beacons 1512) will depend on the layout of the kitchen 1502 and the exit/entrance door 1510 of the kitchen 1502, and the layout of the corridor 1504 outside the kitchen 1502. The layout may be chosen to achieve the ability to detect the presence of the user within the kitchen and to detect the exiting of the bathroom by the user. The detection of the presence of the user and the exit of the user as well as the duration of the presence of the user is referred to herein as presence data.

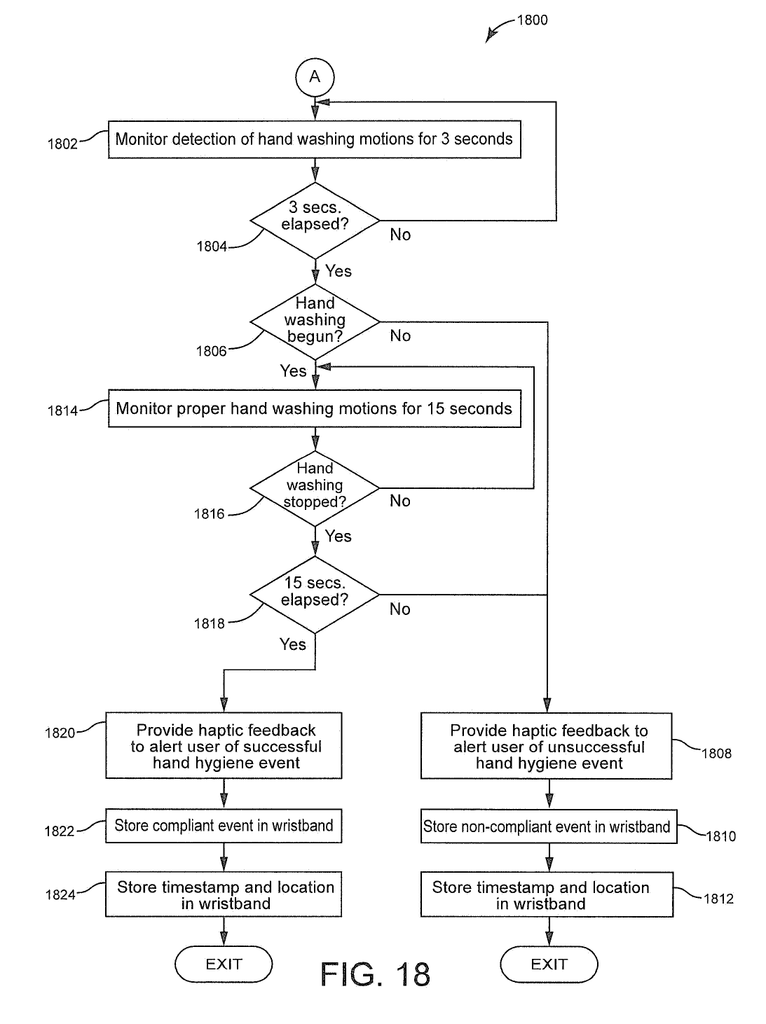

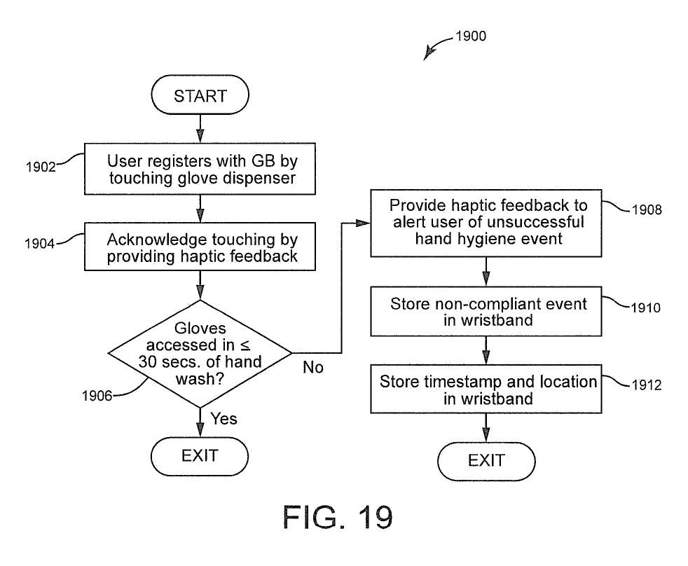

In various embodiments, kitchen hand hygiene system 1500 is further shown to include one or more soap dispenser beacons 1514, and one or more glove dispenser beacons 1516. Beacons 1514 and 1516 may be configured to collect data regarding hand hygiene operations involving washing with soap and retrieving gloves from a dispenser. Further details of processes for collecting data related to these hand hygiene operations are included below with reference to FIGS. 18 and 19

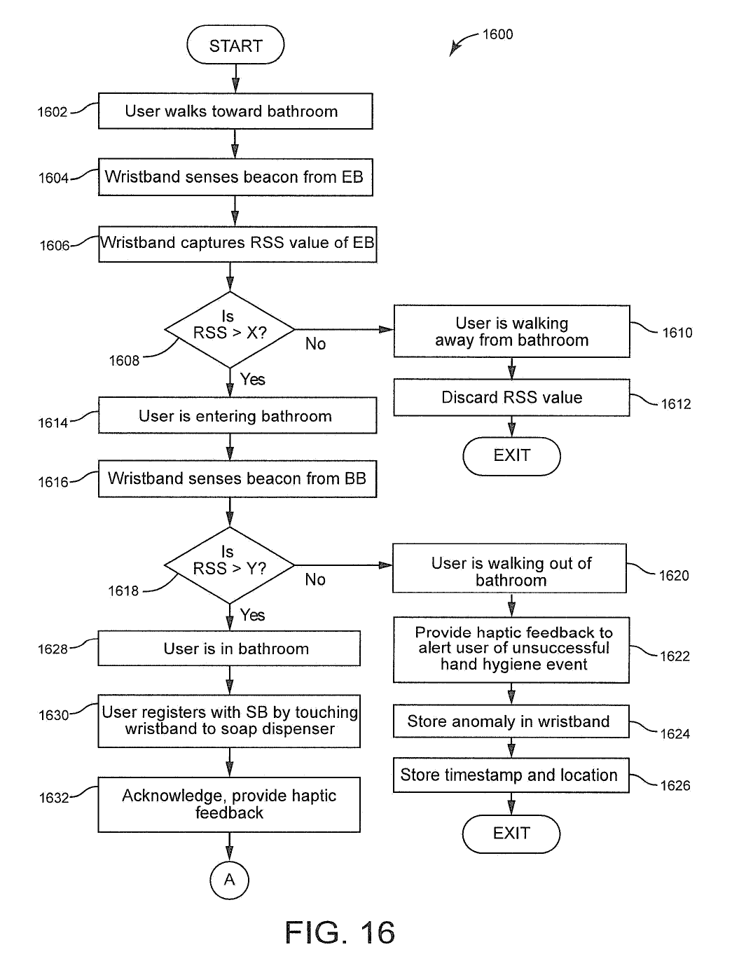

Turning now to FIG. 16, a flow diagram of a process 1600 for monitoring hand hygiene in a bathroom is shown. In various embodiments, process 1600 may be performed by one or more components of the hand hygiene monitoring system 100, described above with reference to FIG. 1. The bathroom may be identical or substantially similar to the bathroom 1402, described above with reference to FIG. 14. Process 1600 begins at step 1602, as a user wearing an HHM wristband approaches a bathroom. At step 1604, the user's HHM wristband senses a beacon message transmitted by an external beacon (EB) located outside of the bathroom. Continuing with step 1606, the HHM wristband captures and stores an RSS value from the EB. The RSS value may be a certain threshold distance from the EB.

At step 1608, the HHM wristband determines whether the RSS value exceeds the user's distance from the EB (i.e., “X”). If the RSS value does not exceed the value of X, the HHM wristband determines that the user is walking away from the bathroom at step 1610, and at step 1612, the HHM wristband discards the stored RSS value. If, however, the HHM wristband determines that the RSS value does exceed the value of X at step 1608, process 1600 proceeds to step 1614, where the HHM wristband determines that the user is entering the bathroom.

At step 1616, the HHM wristband senses a beacon message from a bathroom beacon (BB) located inside of the bathroom. In various embodiments, when the HHM wristband senses the beacon message from the BB, it also captures and stores and RSS value from the BB. The RSS value may be a certain threshold distance from the BB. At step 1618, the HHM wristband determines whether the RSS value exceeds the user's distance from the BB (i.e., “Y”). If the RSS value does not exceed the value of Y, the HHM wristband determines that the user is walking out of the bathroom without having performed a hand hygiene operation at step 1620. In response to detection of the unsuccessful hand hygiene event, the feedback circuit of the HHM wristband provides haptic feedback to the user at step 1622. For example, the haptic feedback may be three vibration pulses from the haptic motor of the HHM feedback circuit. At step 1624, the HHM wristband stores the unsuccessful hand hygiene event as an anomaly in the memory of the HHM, and at step 1626, the HHM wristband stores timestamp and location data related to the anomaly in the memory of the HHM.

If, however, at step 1618, the HHM determines that the RSS value from the BB does exceed the value of Y, process 1600 proceeds to step 1628, with a determination that the user is within the bathroom. At step 1630, the user registers with a soap dispenser beacon (SB) by touching or otherwise bringing the HHM wristband within the vicinity of the soap dispenser. At step 1632, the HHM wristband acknowledges the establishment of communications between the HHM wristband and the SB by providing haptic feedback to the user. For example, the haptic feedback may be a single vibration pulse from the haptic motor of the HHM feedback circuit. Subsequent to step 1632, a process for monitoring soap dispenser access may be performed. In some embodiments, this process is process 1800, described in further detail below with reference to FIG. 18.

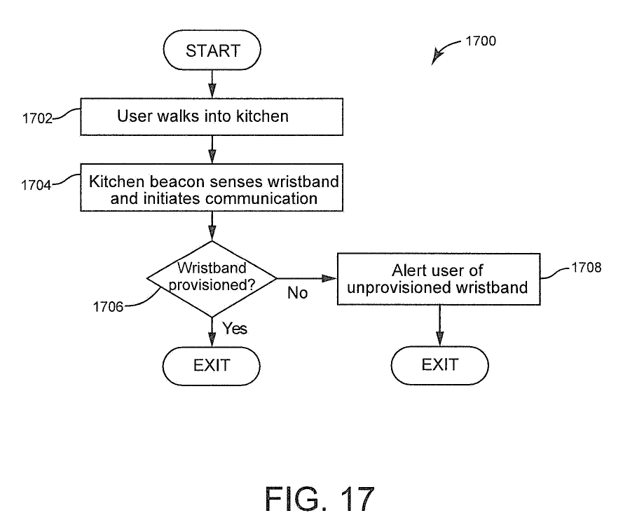

Referring now to FIG. 17, a flow diagram of a process 1700 for monitoring hand hygiene in a kitchen is shown. In various embodiments, process 1700 may be performed by one or more components of the hand hygiene monitoring system 100, described above with reference to FIG. 1. The kitchen may be identical or substantially similar to the kitchen 1502, described above with reference to FIG. 15. Process 1700 begins at step 1702, as a user wearing an HHM wristband enters a kitchen. At step 1704, the user's HHM wristband senses a beacon message from a beacon located in the kitchen and communications are initiated between the HHM wristband the kitchen beacon. At step 1706, communications between the HHM wristband and the kitchen beacon determine whether the HHM wristband is properly provisioned. If it is determined that the HHM wristband is properly provisioned, process 1700 concludes. If, however, it is determined that the HHM wristband is not properly provisioned, process 1700 continues to step 1708, in which the HHM wristband alerts the user to the unprovisioned wristband. For example, the haptic motor of the HHM may perform three vibrational pulses to alert the user of the need to return to the gateway system to re-provision the HHM wristband.

Turning now to FIG. 18, a process 1800 for monitoring soap dispenser access is shown, according to some embodiments. Process 1800 may be performed by one or more components of hand hygiene system 100, described above with reference to FIG. 1. Specifically, process 1800 may be performed by HHM wristband 102 and one or more beacons 104. In some embodiments, the soap dispenser is located in a bathroom (e.g., bathroom 1402, described above with reference to FIG. 14) or a kitchen (e.g., kitchen 1502, described above with reference to FIG. 15).

Beginning at step 1802, the HHM wristband monitors the movements of the HHM wristband for a configurable period of time (e.g., three seconds). At step 1804, the HHM wristband determines whether the configurable period of time has elapsed, and if so, proceeds to step 1806 to determine whether hand washing has begun. In some embodiments, the determination of whether hand washing has begun is based on the movement level sensed by the accelerometer and/or gyroscope of the MM. If it is determined that hand washing has not begun, process 1800 proceed to step 1808 and provides haptic feedback to alert the user of the unsuccessful hand hygiene event. For example, the haptic motor of the HHM provides three vibrational pulses. At step 1810, the HHM wristband stores the non-compliant event, and at step 1812, the HHM wristband stores timestamp and location data related to the non-compliant event.

If, however, it is determined at step 1806 that hand washing has begun, process 1800 proceeds to step 1808, in which the HHM wristband monitors for proper hand washing motions for a configurable period of time. In various embodiments, the hand washing parameters monitored by the HHM wristband may be determined by the location of the beacon. For example, the threshold minimum movement level for hand washing occurring in an operating room may be higher than a threshold minimum movement level for hand washing occurring in a bathroom or a kitchen.

At step 1816, the HHM wristband determines whether the hand washing motions have stopped. If it is determined that they have not stopped, process 1800 reverts to step 1814, and the HHM wristband continues to monitor the hand washing movements. If, however, it is determined that the hand washing motions have stopped, process 1800 proceeds to step 1818, in which the HHM wristband determines whether hand washing motions exceeding a threshold minimum movement level have been performed for a minimum configurable period (e.g., 15 seconds). As described above, the HHM memory device may store threshold minimum movement levels and minimum configurable periods.

If the HHM wristband determines that the hand washing motions have not been performed for a minimum configurable period, the HHM wristband determines that the hand hygiene event does not meet a minimum quality level and HHM wristband proceeds to steps 1808-1812, described above, to store a record of the non-compliant hand hygiene event. If, however, the HHM wristband determines at step 1818 that the hand washing motions have been performed for a minimum configurable period, the process 1800 proceeds to step 1820. At step 1820, the HHM wristband provides haptic feedback to alert the user of the successful hand hygiene event (i.e., the hand hygiene event exceeding a minimum quality level). For example, the haptic feedback may include a single vibrational pulse emitted by the haptic motor of the HHM. At step 1822, the HHM wristband stores a record of the compliant event, and at step 1824, timestamp and location data related to the compliant event are stored in the HHM wristband. Subsequent to the conclusion of process 1800, the HHM wristband may transmit hand hygiene parameters (e.g., timestamp of when the SB communicated with HHM wristband, location of the soap dispenser, whether the hand hygiene event was compliant or not) from the HHM wristband to a central controller (e.g., central controller 112). For example, HHM wristband may transmit the hand hygiene parameters when the HHM wristband is within range of a suitable receiver for the information, or at the end of a user's shift

FIG. 19 depicts a process 1900 for monitoring glove dispenser access, according to some embodiments. Process 1900 may be performed by one or more components of hand hygiene system 100, described above with reference to FIG. 1. Specifically, process 1900 may be performed by HHM wristband 102 and one or more beacons 104. In some embodiments, the glove dispenser is located in a kitchen (e.g., kitchen 1502, described above with reference to FIG. 15). In other embodiments, the glove dispenser is located in another location, for example, a patient examination room or an operating room.

Process 1900 commences at step 1902, in which a user wearing an HHM wristband registers with a glove dispenser beacon (GB) by touching the glove dispenser or otherwise bringing the HHM wristband into close proximity with the glove dispenser. At step 1904, the HHM wristband acknowledges registration with the GB by providing haptic feedback to the user. For example, in some embodiments, the haptic feedback is a single vibration pulse from the haptic motor of the HHM wristband. Continuing with step 1906, the HHM wristband determines whether the user has accessed gloves from the dispenser within a configurable time period (e.g., 30 seconds) after a hand washing event. For example, the HHM wristband may access data stored within the memory of the HHM processing unit to determine the timestamp of the most recent hand washing event. If it is determined that the user has accessed gloves within the configurable time period, process 1900 concludes. In some embodiments, the conclusion of process 1900 includes transmitting hand hygiene parameters (e.g., timestamp of when GB communicated with HHM wristband, location of glove dispenser with GB) from the HHM wristband to a central controller (e.g., central controller 112). For example, HHM wristband may transmit the hand hygiene parameters when the HHM wristband is within range of a suitable receiver for the information (or at the end of a user's shift, as described previously.

If, however, it is determined that the user has not accessed gloves from the dispenser within the configurable time period after the hand washing event, process 1900 may proceed to step 1908, in which the HHM wristband provides haptic feedback to alert the user of the unsuccessful hand hygiene event. For example, in some embodiments, the haptic feedback is three vibration pulses from the haptic motor of the HHM wristband. Continuing with step 1910, the HHM stores a non-compliant event in the memory of the HHM processing unit, and at step 1912, the HHM stores timestamp and location data related to the non-compliant event (i.e., hand hygiene parameters) in the memory of the HHM processing unit. In various embodiments, the HHM wristband may transmit the hand hygiene parameters to the central controller when the HHM wristband is within range of a suitable receiver for the information, or at the end of a user's shift.

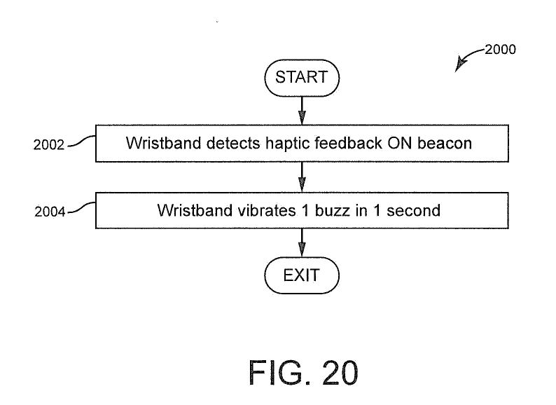

Turning now to FIG. 20, a process 2000 for changing the “personality” of an HHM wristband is shown, according to some embodiments. The “personality” of an HHM wristband may refer to the type of feedback (e.g., haptic feedback, LED indicator feedback) provided to a user via the feedback circuit of the HHM. In various embodiments, process 2000 may be performed by certain components of the hand hygiene monitoring system 100, specifically a HHM wristband 102 and a beacon 104. At step 2002, the HHM wristband detects the presence of a beacon configured to change the personality of the HHM wristband. For example, the beacon may be a haptic feedback ON beacon. At step 2004, process 2000 concludes as the HHM wristband provides haptic feedback (e.g., a single vibration pulse in one second) to alert the user to the HHM wristband personality change.

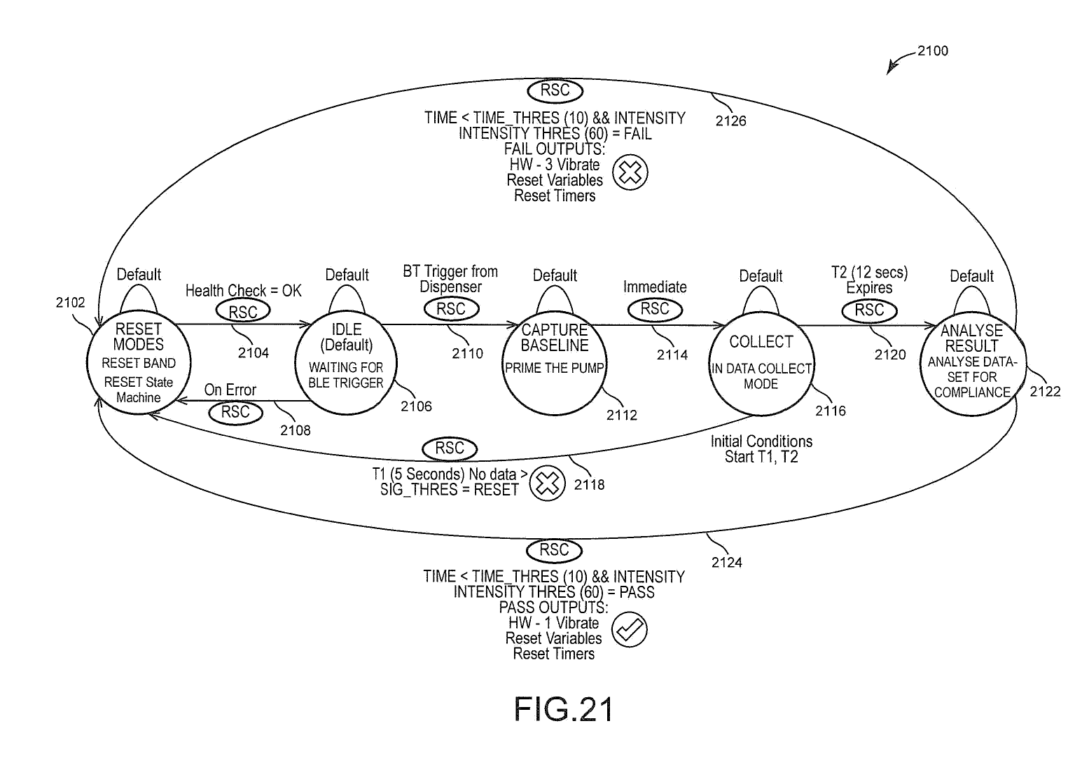

Turning now to FIG. 21, a schematic diagram of a hand hygiene finite state machine 2100 is shown, according to some embodiments. In various embodiments, the finite state machine may be implemented by a processor of an HHM (e.g., processor 122 of HHM 102). Block 2102 depicts the reset mode of the state machine. In various embodiments, the HHM may begin all operations from this mode. At 2104, the HHM requests a state change (RSC) to perform a health check. Block 2106 depicts the idle or default mode for the HHM. In the idle mode, the HHM is waiting for a Bluetooth trigger from a beacon. As described above, in other embodiments, a different communications protocol may be utilized, and the HHM may wait for an appropriate trigger based on the selected protocol (e.g., an NFMI trigger). If the health check returns an error, at 2108 the HHM performs an RSC to return the HHM to the reset mode of block 2102.

At 2110, the HHM receives a Bluetooth (or other beacon mechanism as previously defined) trigger from a beacon (e.g., a soap dispenser beacon) and performs an RSC to advance to block 2112. At block 2112, the HHM is in a capture baseline mode and begins to capture data relating to the hand hygiene operation. At 2114, the HHM performs an immediate RSC to advance to a data collect mode at block 2116. While the HHM is in the data collect mode of block 2116, if the HHM detects that five seconds have elapsed and data is not being collected, the HHM performs an RSC at 2118 to return the HHM to the reset mode of block 2102. If, however, a configurable period (e.g., twelve seconds) has elapsed and data has been successfully collected during the configurable period, HHM performs an RSC at 2120 to advance to block 2122. At block 2122, the HHM is in an analyze result state and the HHM analyzes the collected data for compliance. If the HHM determines that the hand hygiene movements exceeded a minimum intensity level for a minimum period of time, the HHM performs haptic feedback to indicate the compliant event (e.g., one vibrational pulse) and at 2124, the HHM performs an RSC to return to block 2102. If, however, the HHM determines that the hand hygiene movements did not exceed a minimum intensity level for a minimum period of time, the HHM performs haptic feedback to indicate the non-compliant event (e.g., a configurable number of vibrational pulses) and at 2126, the HHM performs an RSC to return to block 2102.

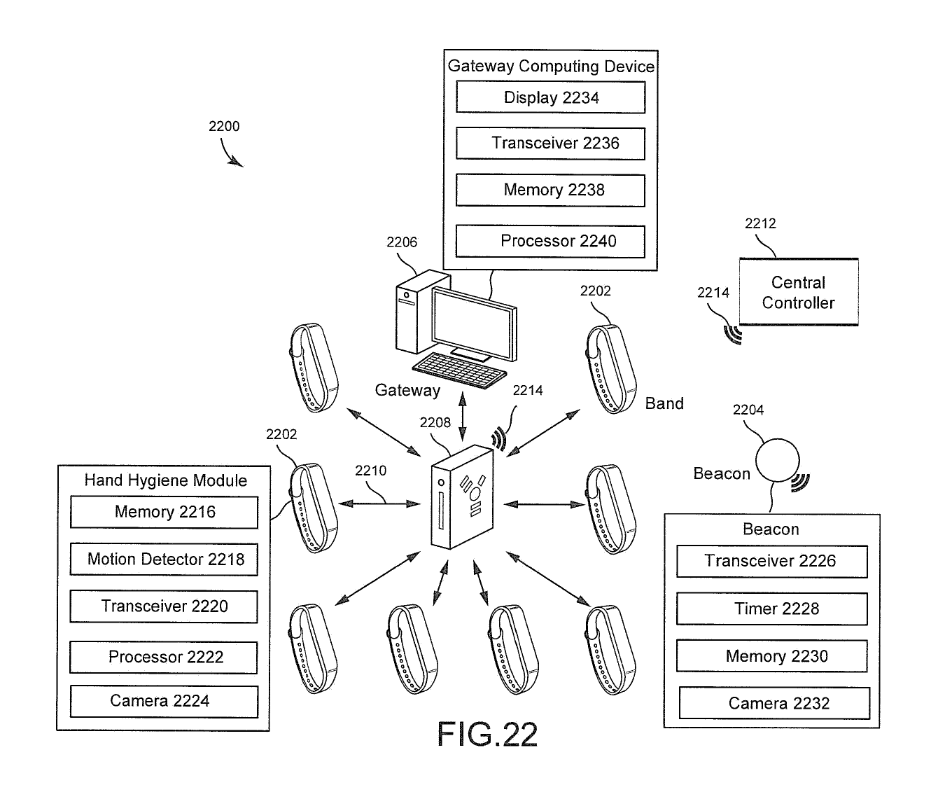

Referring now to FIG. 22, a schematic diagram of a computer vision-enabled hand hygiene system 2200 is depicted. As shown, vision-enabled system 2200 may include components that are substantially similar to hand hygiene system 100, including one or more HHM wristbands 2202, one or more beacons 2204, a gateway system comprising a gateway computing device 2206 and a central hub 2208, and a central controller 2212. However, in addition to the components of HHM wristband described above (i.e., memory 2216, motion detector 2218, transceiver 2220, and processor 2222), HHM wristband is also shown to include a camera 2224. In other embodiments, a camera may be integrated into another wearable device, as well as near or on a handwashing station, or one or more beacons 2204 associated with the handwashing station. Where the vision-enabled hand hygiene system 2200 utilizes cameras 2224 integrated into the wearable devices 2202, the wearable device 2202 may be configured such that the camera 2224 is positioned to face away from the user, and at the hands of the user. In various embodiments, wearable devices 2202 may include wristbands, identification badges (e.g. badge worn around neck, or coupled to the clothing of the worker), or other wearable devices configured to be coupled to the worker.

In one embodiment, the vision-enabled system 2200 may be configured to communicate with a smart phone or other smart device (e.g. tablet computer) or a stationary computer (e.g., gateway computing device 2206) to perform analytics. In some embodiments, the wearable device may include a processor 2222 for processing the data collected by the camera 2224. In other embodiments, the wearable device communicates with other devices (e.g. smart devices or stationary computers) via a wireless connection to allow the other devices to process the captured data. For example, the wearable device may communicate with the other devices using BLE, NFC, or other wireless protocols.

The vision enabled system may be configured to identify objects relevant to a hand hygiene process flow. For example, the vision enabled system may be configured to identify objects relevant to a hand hygiene process flow. For example, the vision enabled system may be configured to recognize a patient's bed or door. Upon determining that the worker is in proximity to the patient, the vision enabled system may communicate with the hand hygiene system to look back over a previous period of time to determine whether any estimated hand washing episodes occurred during the previous period of time. In one embodiment, the previous period of time is thirty minutes; however the previous period of time may be configured to be more than thirty minutes or less than thirty minutes based on factors including, but not limited to, the hand hygiene policy of the location where vision-enabled system 2200 is installed, the occupation of the worker (e.g. doctor may have different requirements than a nurses aid), and the risk level associated with the patient.

In some embodiments, vision-enabled system 2200 may utilize object recognition algorithms to recognize and/or identify hand hygiene devices such as soap dispensers, faucets, hands, hand sanitizers, etc. Vision-enabled system 2200 may further be configured to identify other objects, such as QR codes, 2D barcodes, signage, text, and the like, that are in proximity to the hand washing station. In one embodiment, vision-enabled system 2200 may include RGB+D cameras (Red, Green, Blue+Depth). While RGB+D is disclosed herein, it is contemplated that other visioning systems, such as IR imaging systems, may be used. For example, vision-enabled system 2200 may be configured to project an array of infrared laser points, use an infrared detector (e.g. camera) to determine contours, depth and movement of objects within the field of view. In one embodiment, vision-enabled system 2200 may operate similarly to other vision enabled systems, such as the Microsoft Kinect system, to analyze objects and movements within a field of view of the vision enabled system. A depth dimension may be used to monitor and visualize hand movements associated with a hand washing activity. For example, vision-enabled system 2200 may monitor the hand movements to monitor for certain hand movements associated with proper hand hygiene. In some example embodiments, the cameras and/or the vision enabled system may be coupled near or around a handwashing station or room, rather than on the wearable device.

By using the vision system, the hand hygiene system may be able to monitor a handwashing station in three dimensions, such that the hand hygiene system may further be able to better determine the accurate duration of the washing event itself. Moreover, the video or images captured by the vision enabled system may be stored and uploaded to a central system for later review. For example, the video or images may be reviewed for human review of failures, for machine learning training, for trending analytics, or the like. Furthermore, in using a vision enabled system, the algorithms for determining hand hygiene compliance may be configured to determine if soap or soapy water has reached a large portion of the user's hand. For example, the vision enabled system may be able to distinguish soap or cleaner on the skin from bare or only wet skin. This can further ensure that proper hand hygiene protocol is being performed.

Although the systems and processes above have been described predominantly with respect to hand hygiene operations, the systems and processes described above may be configured to monitor other operations involving a user's hands. For example, a hand movement operation monitoring system may be implemented in a factory to monitor the hand movements of workers performing an assembly process. Beacons may be located within an assembly area to initiate monitoring of hand movements by the wearable device. In some embodiments, the wearable device may utilize monitored parameters to assign a quality level to the hand movement operation (e.g., hand movements that indicate that the worker has assembled a certain amount of parts in a certain period of time). In other embodiments, the wearable device may be configured to continue monitoring hand movement operations when the wearable device moves outside the predetermined distance from the beacon. In another embodiment, a vision-enabled monitoring system may be used to measure the attention of vehicle drivers by monitoring hand movements on a driving wheel, and indicating when attention loss or dangerous excursions from normal behavior occurs.

### Configuration of Exemplary Embodiments

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements can be reversed or otherwise varied and the nature or number of discrete elements or positions can be altered or varied. Accordingly, all such modifications are intended to be included within the scope of the present disclosure. The order or sequence of any process or method steps can be varied or re-sequenced according to alternative embodiments. Other substitutions, modifications, changes, and omissions can be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure can be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Also two or more steps can be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

What is claimed is:

1. A hand hygiene monitoring system, comprising:
a wearable device coupled to a user;
a beacon associated with a hand hygiene station and configured to communicate with the wearable device;
wherein the wearable device is configured to:
initiate monitoring for a hand hygiene operation based on determining the wearable device is located within a predetermined distance from the beacon; and
monitor one or more hand hygiene parameters associated with the hand hygiene operation, the one or more hand hygiene parameters associated with a quality level of the hand hygiene operation performed by the user.

2. The hand hygiene monitoring system of claim 1, wherein the one or more hand hygiene parameters include a duration of the hand hygiene operation and a movement level of the hand hygiene operation.

3. The hand hygiene monitoring system of claim 1, wherein the wearable device is further configured to analyze the one or more hand hygiene parameters to determine the quality level of the hand hygiene operation performed by the user.

4. The hand hygiene monitoring system of claim 1, wherein a space associated with the hand hygiene station is at least one of a bathroom or a kitchen.

5. The hand hygiene monitoring system of claim 1, wherein the wearable device comprises a communication circuit, a processing circuit, an accelerometer, a gyroscope, and a feedback circuit.

6. The hand hygiene monitoring system of claim 5, wherein the communication circuit comprises one of a Bluetooth circuit, a near field magnetic induction circuit, a near field communication circuit, and a radio frequency identification circuit.

7. The hand hygiene monitoring system of claim 6, further comprising:
a central controller in communication with the communication circuit of the wearable device;
wherein the wearable device is configured to transmit the one or more hand hygiene parameters to the central controller during at least one transmission event; and
wherein the central controller is configured to analyze the one or more hand hygiene parameters to determine the quality level of the hand hygiene operation performed by the user.

8. The hand hygiene monitoring system of claim 7, wherein the transmission event is an end of a shift of the user.

9. The hand hygiene monitoring system of claim 7, wherein the transmission event is a determination that the wearable device is located within the predetermined distance from the beacon.

10. The hand hygiene monitoring system of claim 7, wherein the hygiene station is provided in a space within a building, and wherein the central controller is located on a server within the building.

11. The hand hygiene monitoring system of claim 7, wherein the central controller is located on a cloud server.

12. The hand hygiene monitoring system of claim 5, wherein the feedback circuit comprises a haptic motor configured to provide haptic feedback to the user based at least in part on the quality level of the hand hygiene operation performed by the user.

13. A method of provisioning a wearable device in a hand hygiene compliance system, comprising:
receiving, by a hand hygiene compliance system gateway device, a user input from one of a plurality of users;
selecting, by the hand hygiene compliance system gateway device, a selected wearable device from a plurality of wearable devices based on the user input;
transmitting, by the hand hygiene compliance system gateway device, a signal to the selected wearable device to perform a selection indication action; and
associating, by the hand hygiene compliance system gateway device, the one of the plurality of users with the selected wearable device;
wherein the wearable device is configured to monitor one or more hand hygiene parameters associated with a hand hygiene operation.

14. The method of claim 13, wherein the hand hygiene compliance system gateway device comprises a charging hub for the plurality of wearable devices.

15. The method of claim 13, wherein the wearable device comprises a communication circuit, a processing circuit, an accelerometer, a gyroscope, and a feedback circuit.

16. The method of claim 15, wherein the feedback circuit is configured to perform the selection indication action, the selection indication action comprising at least one of a vibration action and an LED flashing action.

17. A monitoring system, comprising:
a wearable device coupled to a user; and
a beacon provided within a space and configured to communicate with the wearable device;
wherein the wearable device is configured to monitor for a hand movement operation when the wearable device is determined to be located within a predetermined distance from the beacon, and further configured to monitor one or more hand movement parameters associated with the hand movement operation, the one or more hand movement parameters associated with a quality level of the hand movement operation performed by the user.

18. The monitoring system of claim 17, wherein the wearable device comprises a communication circuit, a processing circuit, an accelerometer, a gyroscope, and a feedback circuit.

19. The monitoring system of claim 18, wherein the communication circuit comprises one of a Bluetooth circuit, a near field magnetic induction circuit, a near field communication circuit, and a radio frequency identification circuit.

20. The monitoring system of claim 17, wherein the wearable device is configured to continue monitoring for a hand movement operation when the wearable device moves outside the predetermined distance from the beacon after being within the predetermined distance from the beacon.
